(19) United States
(12) Patent Application Publication
(10) Pub. No.: US 2024/0400232 A1
(43) Pub. Date: Dec. 5, 2024

(54) SPACE VEHICLE WITH TESTBED ARCHITECTURE FOR IN-FLIGHT DEVELOPMENT AND TESTING OF OPERATIONAL ALGORITHMS

(71) Applicant: Raytheon Company, Waltham, MA (US)

(72) Inventors: Christopher Mark Cosner, Manhattan Beach, CA (US); Pavan Daryanani, Torrance, CA (US); Joseph Daniel Khair, Torrance, CA (US); Orion Derek Radtke, Culver City, CA (US); Carlos Peralta, Rancho Palos Verdes, CA (US); Jared Dean Stallings, Aurora, CO (US); Jason D. Yingst, Castle Rock, CO (US); Dane Kornasiewicz, Erie, CO (US)

(21) Appl. No.: 17/738,440

(22) Filed: May 6, 2022

(51) Int. Cl. B64G 1/24; B64G 1/40; B64G 1/64

(52) U.S. Cl. CPC B64G 1/244; B64G 1/401; B64G 1/641

(57) ABSTRACT

A space vehicle includes a massless payload. The massless payload comprises dynamically modifiable software configured to indicate one or more actions to be taken by the space vehicle. The space vehicle also includes a primary controller that includes software that is not modified based on modifications to the massless payload, a test controller operatively communicating with the massless payload. The system also includes one or more operational systems including at least one of actuators or sensors of the space vehicle that are controlled based on commands from the test controller during a test condition generated to implement the one or more actions indicated by the massless payload and by the primary controller during normal operation.

### BACKGROUND

The present disclosure relates to space vehicles and, more particularly, to a space vehicle with a testbed architecture for in-flight development and testing of operational algorithms.

Space vehicles may be used for a number of purposes including transport of payload or passengers and tourism. A rideshare-capable space vehicle refers to one that shares a launch vehicle with a primary payload. That is, one or more rideshare-capable space vehicles are those with sufficiently small volume and mass so that they occupy the margin available in the launch vehicle's capability after it has accommodated its primary payload. A rideshare-capable space vehicle, like the launch vehicle that deploys it, may accommodate multiple payloads. For example, the rideshare-capable space vehicle may house a resident space object (RSO) which may be a satellite that is deployed by the space vehicle subsequent to its own deployment from the launch vehicle. Subsequent to deployment of the RSO, the ride-share capable vehicle may perform rendezvous proximity operation (RPO) maneuvers around the RSO.

### SUMMARY

According to one embodiment, a space vehicle is disclosed. The space vehicle includes a massless payload. In one embodiment, the massless payload comprises dynamically modifiable software configured to indicate one or more actions to be taken by the space vehicle. The space vehicle also includes a primary controller that includes software that is not modified based on modifications to the massless payload, a test controller operatively communicating with the massless payload. The space vehicle also includes one or more operational systems including at least one of actuators or sensors of the space vehicle that are controlled based on commands from the test controller during a test condition generated to implement the one or more actions indicated by the massless payload and by the primary controller during normal operation.

In one embodiment, the primary controller is further configured to modify the massless payload based on commands from a ground station and the secondary controller is configured to communicate with the actuators and sensors of the operational system.

In any prior embodiment, the system can further include a deployment mechanism configured to provide retention force to secure the space vehicle to an adapter ring of a launch vehicle during launch and safely release the space vehicle from the adapter ring during deployment.

In any prior embodiment, the massless payload can be modified based on communication with a ground station.

In any prior embodiment, the one or more operational systems include thrusters.

In any prior embodiment, the space vehicle is configured to deploy a payload.

In any prior embodiment, the massless payload is configured to implement a rendezvous proximity operation (RPO) between the space vehicle and the payload.

In any prior embodiment, the massless payload is configured to determine one or more actions to be taken by the space vehicle as part of the RPO.

In any prior embodiment, the controller is configured to issue one or more commands to the thrusters based on the one or more actions.

In any prior embodiment, the vehicle can include a modular liquid propellant thruster system configured to be affixed to the space vehicle.

In any prior embodiment, the modular liquid propellant thruster system is one of the one or more operational systems and includes the thrusters.

In any prior embodiment, two of the thrusters of the modular liquid propellant thruster system produce different thrust forces.

Also disclosed is a method of assembling a space vehicle. The method can include: arranging a massless payload, wherein the massless payload is dynamically modifiable software that is configured to indicate one or more actions to be taken by the space vehicle, wherein the massless payload is operatively stored on test controller; configuring a primary controller to provide modifications to the massless payload that are received from a ground location, the primary controller having operational software is not modified based on modifications to the massless payload; arranging one or more operational systems coupled to the primary controller and the secondary controller, the one or more operational systems including actuators or sensors of the space vehicle that are controlled based on commands from the primary controller during normal operation; and allowing the test controller to access the one or more operational systems during a testing operations to provides one or more actions indicated by the massless payload.

In any prior method, arranging the one or more operational systems can include arranging thrusters.

In any prior method, the method can further include arranging a payload for deployment by the space vehicle.

In any prior method, arranging the massless payload includes configuring the massless payload to implement a rendezvous proximity operation (RPO) between the space vehicle and the payload.

In any prior method, arranging the massless payload includes configuring the massless payload to determine one or more actions to be taken by the space vehicle as part of the RPO.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 illustrates deployment of a resident space object by a space vehicle with a testbed architecture according to one or more embodiments;

FIG. 2 details aspects of the testbed architecture of the space vehicle according to one or more embodiments;

FIG. 3 is a process flow of a method of testing RPO maneuvers using the testbed architecture of the space vehicle according to one or more embodiments; and

FIG. 4 is a block diagram of a modular liquid propellant thruster system of a space vehicle according to one or more embodiments.

### DETAILED DESCRIPTION

Embodiments detailed herein relate to a space vehicle with a testbed architecture for in-flight development and testing of operational algorithms. The architecture includes middleware that allows operational control of actuators and sensors to be transparent to higher level algorithms. Thus, one or more embodiments of the architecture may allow for real-time testing of one or more algorithms that affect operational controls without the software of interface drivers of the operational controls having to be modified. Stated differently, space vehicle can have a “main” or primary controller that controls the operation of elements on the vehicle (e.g., thrusters, sensors, etc.). At time, a second or test controller can be given direct access to control the elements in order to test certain operational algorithms. This can allow for testing to occur without changing the main/primary controller.

The one or more algorithms are software and may be referred to as a “massless payload.” The space vehicle with this architecture acts as a real-time testbed. For example, different RPO algorithms may be uploaded and tested to maneuver around an RSO. According to the example, while the different algorithms ultimately control operation of the thrusters to perform different proximity maneuvers, the middleware allows the algorithms to be implemented without modifications to (or even knowledge of) the underlying control commands (i.e., any software directly interfacing with the thrusters in the main controller). Additionally, as detailed, a modular liquid propellant thruster system is used with the rideshare-capable space vehicle with the testbed architecture.

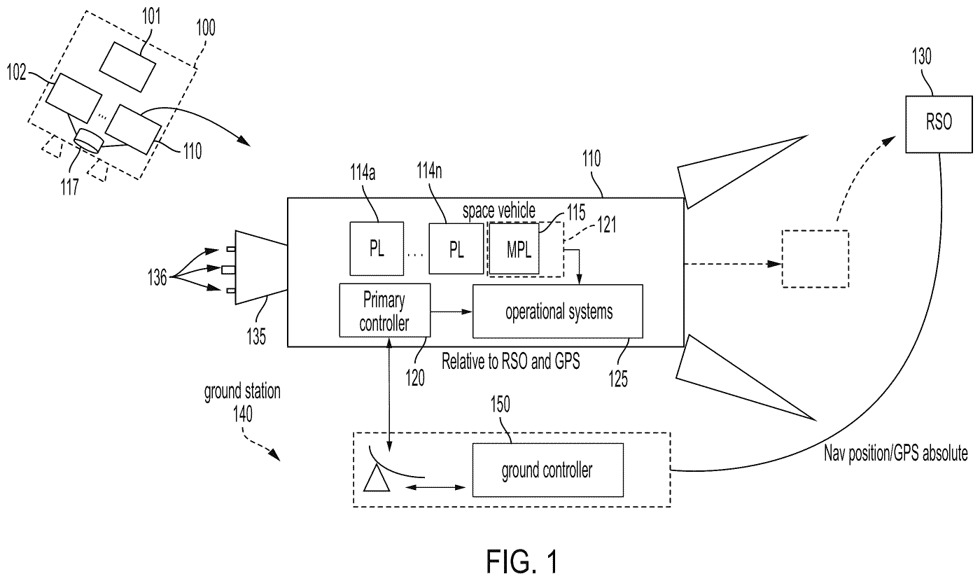

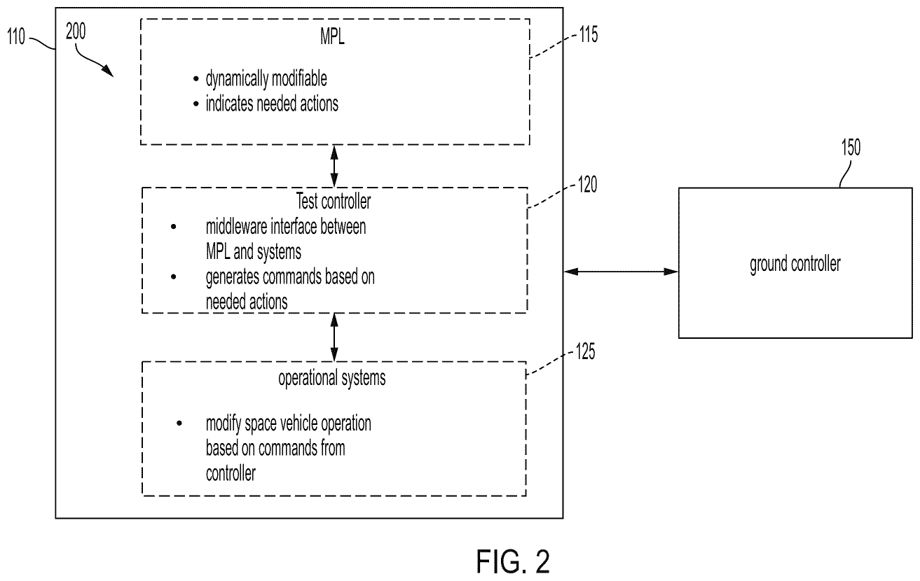

FIG. 1 illustrates deployment of an RSO 130 by a space vehicle 110 with a testbed architecture 200 (FIG. 2) according to one or more embodiments. As indicated, the space vehicle 110 is rideshare-capable and shares, along with one or more other payloads 102, space in a launch vehicle 100 that is left over after a primary payload 101 is accommodated. The launch vehicle 100 includes a launch adapter ring 117 to which one or more rideshare capable space vehicles (e.g., 102 through 110) can be attached. The space vehicle 110 includes a deployment mechanism 119 through which the space vehicle attaches to the launch vehicle 100 during launch. The deployment mechanism 119 is configured to allow the space vehicle 110 to safely deploy from the launch adapter ring 117 where it was attached to the launch vehicle 100 during launch. The deployment mechanism 119 may, in one embodiment, be a specifically designed structural element to allow a rideshare capable space vehicle to attach to the launch adapter ring 117 of the launch vehicle. Space vehicles that do not have a rideshare capable architecture do not normally include such a deployment mechanism for attaching to the launch adapter ring 117. This mechanism may provide both retention force and load path as well as the necessary actuation to separate the rideshare vehicle from the launch adapter. It is low profile to minimize volume and it is designed to mate to the standardized port of the launch adapter as well as to maintain sufficient dynamic clearance throughout all stages of the mission including testing, mate, launch and separation.

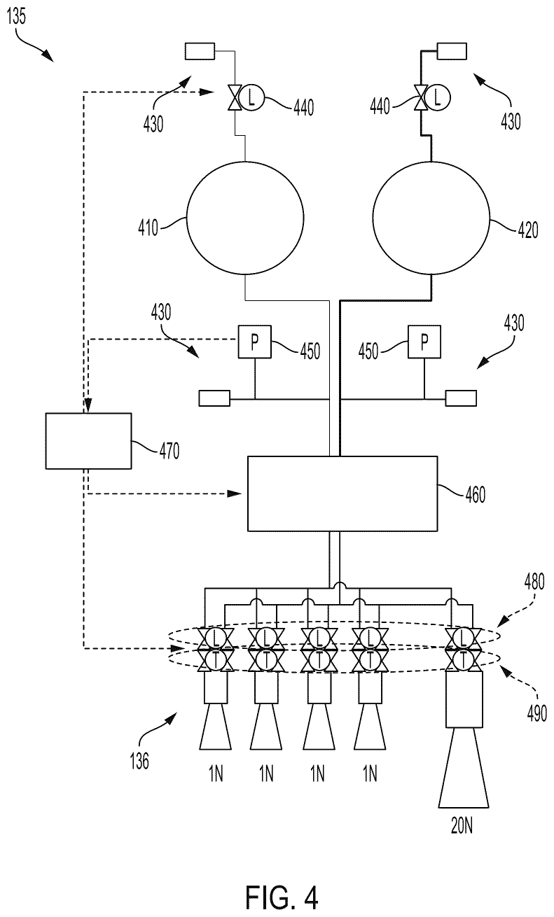

The space vehicle 110 may include a number of payloads (PL) 114a through 114n (generally referred to as 114) in addition to the massless payload (MPL) 115 of interest. The massless payload 115 is shown as being part of second controller 121 in FIG. 1. This controller could be included in the primary controller 120 in one embodiment. Exemplary payloads 114 include experimental payloads, telescopes, and materials for radiators (e.g., vanadium dioxide). The RSO 130, which is another exemplary payload 114 of the space vehicle 110, is shown deployed. The space vehicle 110 is propelled by a modular liquid propellant thruster system 135 with one or more thrusters 136, as further detailed with reference to FIG. 4.

The space vehicle is designed to be accommodated as a ride-share and to be useful as a testbed for the development of algorithms for orbital maneuvering by ensuring it satisfies the constraints associated with the available launch margins including mass and volume while still maintaining sufficient maneuvering capability for testing new algorithms. As an example, the following methodology is used to ensure the space-vehicle meets those constraints associated with the development of algorithms for RPO (Rendezvous Proximity Operations) maneuvers.

Assume a system capable of an integer number of RPO maneuvers, M. and assume these maneuvers establish natural motion circumnavigation, NMC. Three components of a single maneuver to establish the NMC.

$$Δ {V}_{x} = \frac{η}{2} {Y}_{ro} ; \qquad ( 1 )$$

$$Δ {V}_{y} = O ; \qquad ( 2 )$$

$$and$$

$$Δ {V}_{z} = \pm η {A}_{{z}_{tgt}} , \qquad ( 3 )$$

where η=mean motion of RSO, assumed (RAD/sec) to be circular for these purposes; Yᵣₒ=relative Y-Coor of Inst. Center of motion and A_{Z}_{_{tgt}}=Amplitude of motion in Z-Direction of target.

Thus the Magnitude of individual, NMC maneuver ΔVᵢ, can be represented as

$$Δ {V}_{í} = [ Δ {V}_{x}^{2} + Δ {V}_{y}^{2} + Δ {V}_{z}^{2} ] , \qquad ( 4 )$$

and total ΔV required for M RPO MANEUVERS is:

$$Δ {V}_{TOT} = M Δ {V}_{i} . \qquad ( 5 )$$

From the Rocket Equation:

$$Δ {V}_{TOT} = g {I}_{SP} ln ( \frac{{M}_{I}}{{M}_{bo}} ) \qquad ( 6 )$$

where g=Accel due to gravity (M/s²), I_{SP}=Specific Impulse (sec) and M_{I}=Initial Mass (Kg); and M_{bo}=Mass at Burnout (Kg)=“dry mass”; and

$${M}_{I} = {M}_{bo} + {M}_{prop} . \qquad ( 7 )$$

Where Mₚᵣₒₚ=propellant Mass (Kg).

Then:

$${M}_{prop} = ( {e}^{\frac{Δ {V}_{TOT}}{gIsp}} - 1 ) {M}_{bo} . \qquad ( 8 )$$

This means that SV is sized so that the propellant to dry mass ratio is approximately

$${MR}_{PD} = ( {e}^{\frac{Δ {V}_{TOT}}{gIsp}} - 1 ) \qquad ( 9 )$$

Incorporating the limited launch mass available for a rideshare configuration

$${M}_{I} < {M}_{\frac{R}{S}} \qquad ( 10 )$$

where M_{R/S} is the rideshare limit mass, the design is constrained such that the dry mass complies with

$${M}_{b / o} < {M}_{\frac{R}{S}} \cdot \frac{1}{{e}^{\frac{Δ {V}_{TOT}}{gIsp}}} \qquad ( 11 )$$

and to accommodate loads the center of mass is constrained to

$${L}_{l} > {M}_{I} {X}_{CM} \qquad ( 12 )$$

where Lₗ is the allowable load limit with X_{CM}<Lₗ guiding the physical placement of heavier items in the design, such as the liquid propellant and the batteries.

Because the values for η are high in LEO (low earth orbit), the values for ΔVₜₒₜₐₗ are respectively large, equations (9), (10), and (11) are of increased importance when optimizing the design for LEO, as contrasted with design for other orbit regimes.

As generally discussed above, the space vehicle 110 also includes a controller 120 and operational systems 125. The controller 120 is further discussed with reference to FIG. 2 and may include one or more memory devices and processors to generate commands to one or more operational systems 125 to control operations of the space vehicle 110. According to the testbed architecture 200, the second or test controller 121 functions as middleware. That is, the software implemented by the controller 121 is common to any MPL 115 and need not change based on the particular algorithm being tested. While the MPL 115 and controller 121 are shown and discussed separately for explanatory purposes, common processors or memory devices may be shared among the primary and secondary (or test) controllers. In operation, the primary controller 120 may have the ability to allow the test controller 121 to directly access the operational system. This will allow the test controller 121 to change how the vehicle operates by simply changing the MPL 115. When the test of the MPL 115 is complete, the primary controller 120 can retake control and the space vehicle 110 will revert back to normal operation. In this way, several tests can be performed without ever having to change the operation of the primary controller 120. That is, the primary controller 120 includes software that is not modified based on modifications to the massless payload.

The controller 121 facilitates an interface between any test algorithms implemented by the MPL 115 and the operational systems 125, such as thrusters, that facilitate operation of the space vehicle 110 based on commands from the controller 120. A ground station 140 is shown communicating with the space vehicle 110. The ground station 140 includes a ground controller 150 that is also further discussed with reference to FIG. 2. The ground station 140 may provide the modified or new algorithms to be tested at the space vehicle 110 based on the testbed architecture 200 of the space vehicle 110.

FIG. 2 details aspects of the testbed architecture 200 of the space vehicle 110 according to one or more embodiments. As shown, the testbed architecture 200 generally includes three functional portions or layers. The first layer is the MPL 115 that is dynamically modifiable. The algorithms implemented by the MPL 115 may be uploaded from the ground controller 150 during a mission by the space vehicle 110, for example. In a specific example, the algorithms implemented by the MPL 115 can be uploaded to the primary controller 120. That controller 120 will ensure that the communication is complete/accurate and then provides it to MPL 115 (e.g,. stored in memory of the test controller 121). The primary controller 120 can then give the test controller 121 access to the operational systems 125 such that the MPL 115 will have temporary control of the operational system 125. When the primary controller has given the test controller 121 access, such a state can be referred to a test, test condition, testing operation or the like. Other times shall be referred to as normal state, condition, or the like.

As illustrated, the second layer of the testbed architecture 200 is the controller 121, which functions as an interface between the MPL 115 and operational systems 125, which represent the third layer. The controller 121 is common to any MPL 115 and, thus, functions as middleware. That controller 121 can be part of the main controller 120 without departing from the teachings herein. Based on actions indicated by the MPL 115, the controller 121 may generate commands to the operational systems 125, and which implement the commands to affect operation of the space vehicle 110. The software processed by the controller 121 need not change based on different software (i.e., MPL 115) being implemented in the first layer. The operational systems 125 include actuators and sensors for attitude control (e.g., thrusters 136, reaction wheel, torque rod, star trackers, inertial measurement units (IMUs)), temperature sensors, and any other sensors and actuators of the space vehicle 110.

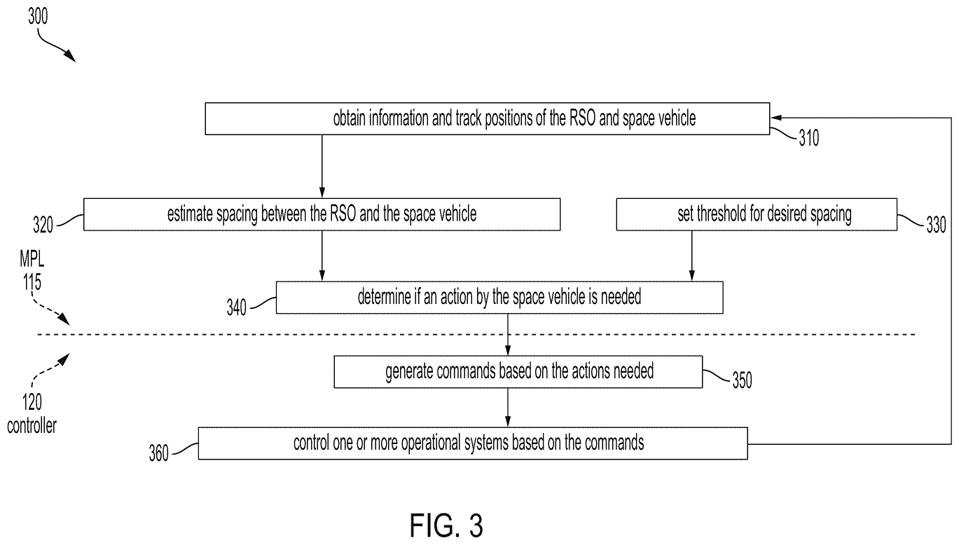

FIG. 3 is a process flow of a method 300 of testing RPO maneuvers using the testbed architecture 200 of the space vehicle 110 according to one or more embodiments. As indicated, the processes may be performed by a combination of the MPL 115 and the controllers 120/121. As illustrated, the processes at blocks 310 through 340 may be performed by the MPL 115. These processes (more specifically, the software that implements these processes) may be modified or changed dynamically. As also illustrated, the processes at blocks 350 and 360 may be performed by the controller 121 and may be reused for different MPL 115 without modification of any of the underlying software used by the primary controller 120.

At block 310, obtaining information and tracking positions of the RSO 130 and the space vehicle 110 is performed by the MPL 115. The tracking algorithm (e.g., using an extended inertial Kalman filter) may be modified or replaced based on communication with the ground station 140, for example. The information used in the tracking may include telemetry data obtained from the ground station 140 and RSO measurements obtained from an image processor that is part of the controller 120.

At block 320, estimating spacing between the RSO 130 and the space vehicle 110 (i.e., conjunction assessment) may rely on the information obtained at block 310. That is, based on the estimated positions of the RSO 130 and the space vehicle 110, the spacing between them may be calculated. Like the tracking, at block 310, the assessment at block 320 may be performed using different algorithms based on dynamic changes uploaded by the ground station 140. At block 330, setting a threshold for a desired spacing between the RSO 130 and the space vehicle 110 may be a function of a guidance controller that may be modified dynamically.

At block 340, determining if an action by the space vehicle 110 is needed may be performed by a mission orchestrator within the MPL 115 that may also be modified dynamically. Based on the particular algorithm being implemented, the mission orchestrator may compare estimated positions of the RSO 130 and the space vehicle 110 with waypoints to determine if the space vehicle 110 should maneuver from its current position and, if so, in which direction. The determination may be provided to the controller 120 as actions needed by one or more operational systems 125.

At block 350, generating commands based on the actions indicated, at block 340, by the MPL 115 may be performed by a command generator within the controller 120. Regardless of changes within the MPL 115, its interface with the controller 120 need not change. As such, the controller 120 itself need not change based on dynamic changes to aspects of the MPL 115. At block 360, the controller 120 controls one or more operational systems 125 based on the commands generated at block 350. The processes shown in FIG. 3 may be performed iteratively. For example, control of one or more operational systems 125 (at block 360) may be followed by another iteration beginning with obtaining information (at block 310).

FIG. 4 is a schematic diagram of a modular liquid propellant thruster system 135 of a space vehicle 110 according to one or more embodiments. The exemplary modular liquid propellant thruster system 135 has propellant tanks that include an oxidizer reservoir 410 and a fuel reservoir 420. Fill and drain valves 430 and single seat lathing valves 440 are indicated. Pressure transducers 450 measure the pressure in the oxidizer reservoir 410 and the fuel reservoir 420. Control electronics 470 control flow control and filtering components 460 to supply the thrusters 136 via dual seat latching valves 480 and thruster latching valves 490, as shown. As indicated, the exemplary modular liquid propellant thruster system 135 includes four thrusters that provide a thrust force of 1 Newton (N) and one thruster that provides a thrust force of 20N.

The modularity of the modular liquid propellant thruster system 135 facilitates a design of the rest of the space vehicle 110 prior to consideration of the thruster system. This is the opposite of prior approaches, which begin with the propulsion design. According to one or more embodiments, based on the payloads of the space vehicle 110 and on the planned mission, the modular liquid propellant thruster system 135 may be selected. Mass and volume of the thruster system increase with increased maneuverability. Thus, more specifically, the modular liquid propellant thruster system 135 may be selected by balancing the mass and volume, which must be minimized to maintain rideshare capability, with maneuverability, which is maximized to complete the planned mission.

The corresponding structures, materials, acts, and equivalents of all means plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A space vehicle comprising:
a massless payload, wherein the massless payload comprises dynamically modifiable software configured to indicate one or more actions to be taken by the space vehicle;
a primary controller, wherein the controller includes software that is not modified based on modifications to the massless payload;
a test controller operatively communicating with the massless payload; and
one or more operational systems including at least one of actuators or sensors of the space vehicle that are controlled based on commands from the test controller during a test condition generated to implement the one or more actions indicated by the massless payload and by the primary controller during normal operation.

2. The space vehicle of claim 1, wherein the primary controller is further configured to modify the massless payload based on commands from a ground station the secondary controller is configured to communicate with the actuators and sensors of the operational systems.

3. The space vehicle according to claim 1, further comprising:
a deployment mechanism configured to provide retention force to secure the space vehicle to an adapter ring of a launch vehicle during launch and safely release the space vehicle from the adapter ring during deployment.

4. The space vehicle according to claim 1, wherein the massless payload is modified based on communication with a ground station.

5. The space vehicle according to claim 1, wherein the one or more operational systems include thrusters.

6. The space vehicle according to claim 5, wherein the space vehicle is configured to deploy a payload.

7. The space vehicle according to claim 6, wherein the massless payload is configured to implement a rendezvous proximity operation (RPO) between the space vehicle and the payload.

8. The space vehicle according to claim 7, wherein the massless payload is configured to determine one or more actions to be taken by the space vehicle as part of the RPO.

9. The space vehicle according to claim 8, wherein the controller is configured to issue one or more commands to the thrusters based on the one or more actions.

10. The space vehicle according to claim 3, further comprising a modular liquid propellant thruster system configured to be affixed to the space vehicle.

11. The space vehicle according to claim 10, wherein the modular liquid propellant thruster system is one of the one or more operational systems and includes the thrusters.

12. The space vehicle according to claim 11, wherein two of the thrusters of the modular liquid propellant thruster system produce different thrust forces.

13. A method of assembling a space vehicle, the method comprising:
arranging a massless payload, wherein the massless payload is dynamically modifiable software that is configured to indicate one or more actions to be taken by the space vehicle, wherein the massless payload is operatively stored on test controller;
configuring a primary controller to provide modifications to the massless payload that are received from a ground location, the primary controller having operational software is not modified based on modifications to the massless payload;
arranging one or more operational systems coupled to the primary controller and the secondary controller, the one or more operational systems including actuators or sensors of the space vehicle that are controlled based on commands from the primary controller during normal operation;
wherein the primary controller is arranged to allow the test controller to access the one or more operational systems during a testing operation to perform one or more actions indicated by the massless payload.

14. The method according to claim 13, wherein the arranging the one or more operational systems includes arranging thrusters.

15. The method according to claim 13, further comprising arranging a payload for deployment by the space vehicle.

16. The method according to claim 13, wherein the arranging the massless payload includes configuring the massless payload to implement a rendezvous proximity operation (RPO) between the space vehicle and the payload.

17. The method according to claim 16, wherein the arranging the massless payload includes configuring the massless payload to determine one or more actions to be taken by the space vehicle as part of the RPO.

18. The method according to claim 17, wherein the configuring the controller includes the controller issuing one or more commands to the thrusters based on the one or more actions.

19. The method according to claim 14, further comprising affixing a modular liquid propellant thruster system to the space vehicle.

20. The method according to claim 19, wherein the affixing the modular liquid propellant thruster system includes coupling the thrusters to the space vehicle.

21. The method according to claim 20, further comprising selecting the modular liquid propellant thruster system based on balancing minimizing of mass and volume of the modular liquid propellant thruster system with maximizing of maneuverability of the modular liquid propellant thruster system.
